(19) United States
(12) Patent Application Publication
(10) Pub. No.: US 2009/0308492 A1
(43) Pub. Date: Dec. 17, 2009

(54) CELL WITH INSULATING CONNECTOR FOR THE DISPENSING OF REFRIGERATED DRINKS, IN PACKAGES INTERCHANGEABLE AND PROVIDED WITH TAP

(76) Inventors: Ernesto Benvenuto, Montebelluna (IT); Armando Serena, Venegrazzu del Montello (IT)

Correspondence Address: Andrew F. Bodendorf, P.O. BOX 34175, WASHINGTON, DC, 20043, US

(21) Appl. No.: 12/374,041

(22) PCT Filed: Jul. 18, 2007
(86) PCT No.: PCT/EP2007/006388

§ 371 Date: Jan. 15, 2009

(30) Foreign Application Priority Data
Jul. 18, 2006 (IT) BL2006A000025

(51) Int. Cl. B65B 1/04; B67D 5/62; B67D 5/06

(52) U.S. Cl. 141/362; 222/146.6; 222/183

(57) ABSTRACT

The present invention relates to a new constructive solution of a refrigerating cell, or in any case for the thermal treatment of drinks contained in not rigid pockets or packages and with standardized capacity, to be gradually dispensed, with control at a relative distance of the tap, without thermal dispersion or dispersion of the drink. It is the main feature of the invention to provide for the carrying out of a refrigerating, or thermal treatment, cell (1), which is provided with opening (12), for the insertion and replacement of the standardized packages (C1), said cell opening (12) being equipped with a connector thereof (34) having the edge intended to contact the outlet mouth (R3) of a tap (R) provided with a collar (20) which is self centering and able to be accommodated in a fork (31) of a jacket (30), which is fastened to the opening (12) and allows the application of a leverage which is adapted to activate the fins (R2) of the tap (R) without causing oscillations and movements thereof.

The present invention relates to a new constructive solution of a refrigerating cell, dimensioned for the holding and dispensing of drinks which are indicatively contained in not rigid pockets or packages and with standardized capacity, being designed in particular to avoid as much as possible the thermal dispersion usually due to the presence of the actuating device of the tap, and to avoid the dispersion of the drink from the mouth of the tap.

It is the main feature of the present invention to provide for the carrying out of a refrigerating, or thermal treatment, cell, which is provided with a front opening, for the insertion and replacement of the standardized drink packages, said cell opening being equipped with a connector having the upper edge intended to contact a mouth of a tap of the piston type, to which a collar is applied, self centering and able to be accommodated in a fork which is present at an end of the support grid of the drink package to be used, beside at an edge which is present in a jacket integral to the cell opening and intended to hold and direct said connector and an actuating leverage of said tap, in order to allow the dispensing of the drink, without said tap, under the effect of the leverage movement, undergoing such vertical flexures to hinder or reduce the opening of the tap and without having thermal dispersions due to the remote activation of the tap.

It is known that some food drinks, for example table wine, or fruit juices, beside being available in bottles and packages, for example, a one-litre package, are also available in packages, for example, 3- or 5-litre packages, which allow substantial savings in the bottling step and, therefore, on the cost for the consumer, the quality of the liquid contained being equal.

Nevertheless, while the standard bottles allow an easy pouring of the drink in each glass, the larger packages are heavy and hard to handle, therefore require the presence of a tap, located at the base thereof, in order to be able to dispense the liquid without moving the package.

Among the several tap types available for this use, the piston ones turned out to be particularly efficient and widespread, which are essentially composed of an inlet mouth with flanging, to be applied at the base of one of the package walls, and of an orthogonal tap body, inside which a cylinder acting on a membrane is made slidable, in order to determine its opening or closure position on the underlying dispensing funnel, essentially in accordance with the teaching of EP 0 432.070.

According to the solution proposed in this patent, the piston movement, in order to allow the drink dispensing, is ensured by the manual lifting of a pair of side brackets, projecting from the tap body and being integral to the piston, said piston being associated to an elastic means which, in reaction to the lifting action, goes back to the closure position, whenever the action of manually lifting the brackets and the piston thereof ceases.

Usually, the standardized package for wine or other drink to be gradually poured is located on a support plane, for example, on the lunch or dinner table of the family or the group of people who use it, and it is not removed anymore, until the depletion thereof, to be then replaced by another similar package of the same drink, again provided with a tap thereof of the described type.

More advantageously, dealing with wine or other drink which is to be drunk at a proper temperature, it would be necessary to put each time the package in a refrigerating cell, in order to be then located on the dispensing site at each lunch or dinner but, actually, this system is hardly followed, for the unease it determines, beside the fact that, in the depletion step of the contents, in any case the problem arises of a second package to be refrigerated.

For this drawback, the state-of-the-art technique tried to find a remedy by making a refrigerating cell in which the drink container is firmly positioned in the refrigerating space thereof, while a particular dispensing tap thereof, as a sleeve, is entrapped by a vertically rotatable bracket, and while an underlying eccentric lever carries said tap from its closure position to the opening or drink dispensing position, such as proposed by FR 2.744.996.

According to this solution, while ensuring a sufficient rigidity of the tap, compared to the flexible surface of the container supporting it, a substantial thermal dispersion is caused on the cell wall where the tap is located, due to the room required by the horizontal translation movement of the control lever of the tap, rapidly hindering the refrigerating action of the cell.

Still according to said known solution, the gap between the dispensing hole of the tap and the support plane, for example, of the glass, determines a dispersion of the drink, which only partially centres the glass, also dirtying the support base of the cell and requiring, in any case, a frequent cleaning also of non-easily accessible parts.

On the other hand, irrespective of the thermal dispersion, when placing the drink container inside an isolated space, while using a tap of the type corresponding to the above-mentioned patent EP 0 432.070, the activation of the piston fins of such tap always requires the presence of an activation leverage at a relative distance, since said fins are not directly reachable by the operator's hand.

Leverages are known, although not currently applied to containers stored in controlled temperature cells, having the object to make the activation of the fins of the tap piston easier, by directly acting with the glass in aligning step with the mouth of the tap, and such leverages being applied to an angular bracket, which has a vertical wall against which a tap flange abuts, with the aim to avoid its vertical flexure, when the leverage biases its fins for the drink dispensing control.

In practice, said solution, even though not applicable to freezing compartments, does not prevent the tap to vertically move and to make the dispensing condition always uncertain, always requiring the involvement of both hands, in order to achieve the necessary stability.

The presence of this leverage further poses the drawback that, by increasing the gap between the dispensing mouth of the tap and the glass position, a dispersion of the drink and a not always perfect cleaning of the positioning space for the glass occur.

Another problem that in current leverage devices arises, even if applied to not refrigerated drinks, is given by the difficulty to be able to rapidly replace the empty container, so that the new tap is positioned in contact with the leverage always in the ideal conditions of rigidity and operation.

It is the main task of the present invention to be able to provide a refrigerating, or in any case a thermal treatment, cell, for the housing and a gradual dispensing of drinks, which cell ensures the best preservation of the inner temperature thereof, without substantial thermal dispersions due to the presence of a control device or leverage at a relative distance, for the activation of the dispensing tap.

Within the scope of this task, another important object of the present invention is to be able to activate the control leverage of the drink dispensing without its bias causing a flexure or a vertical translation of the tap, therefore always ensuring the best stability conditions of the tap and the control of the drink quantity and outlet direction.

A further object of the invention is to be able to provide a refrigerating or thermal treatment cell for drinks, the dispensing of which is made possible by using a single hand, for example, in the aligning of the glass against the leverage base.

Another important object of the invention is to be able to associate to the dispensing mouth of the tap a sleeve or connector which come along with and direct the coming out of the drink to the glass, avoiding the dispersions and the consequent poor cleaning, in relation to the height or gap with said glass and, therefore, to the leverage length.

Again, another object of the present invention is to be able to ensure the constant interchangeability of the packages to be applied to a single connector and the tap control leverage thereof,

The proposed task, and the other specified objects are in fact perfectly achieved by the present invention, which provides the carrying out of a refrigerating or thermal treatment cell, which is provided with a front opening equipped with a connector thereof, vertically moveable and having the upper edge intended to contact the outlet edge of the tap, such tap being pre-fastened to the treatment space of the cell and, therefore, self-centered to a fork or bracket, integral to the opening, which bracket makes it vertically rigid, due to the fact of engaging on a collar with shoulder which is preventively applied to the outlet end of the tap of the package of the drink to be dispensed.

A better understanding of the present invention and a verification of the achievement of the specified objects thereof is proposed and illustrated below, according to a preferred, although not exclusive, constructive embodiment thereof, also with the aid of 9 schematic Figures shown in the four annexed tables in which:

FIG. 1 represents a side vertical view of a drink container, being shown according to a constructive embodiment having standardized and commercially available capacity and dimensions, and being shown with application of a dispensing tap which is commercially known and which is of the piston type, essentially corresponding to the object in EP 0 432.070;

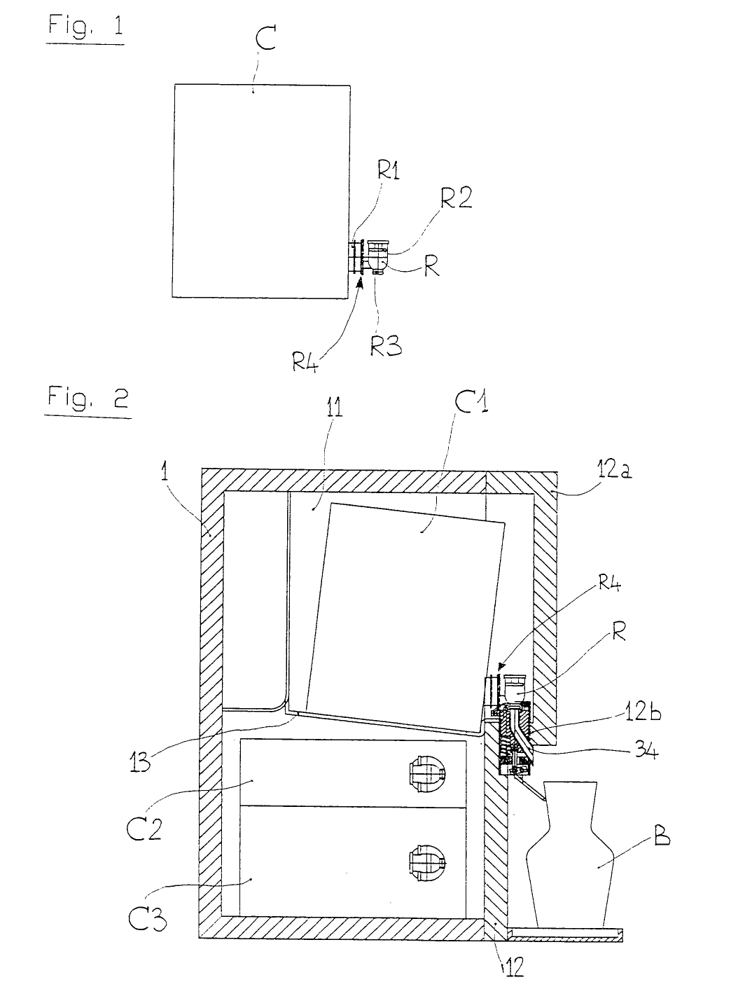

FIG. 2 represents a vertical and axial sectional view of a cell for the refrigeration or in any case for the thermal treatment of one or more standardized drink packages as in FIG. 1, one of such packages being positioned so as to be able to gradually dispense the drink thereof until depletion, while preserving it essentially always at the desired temperature;

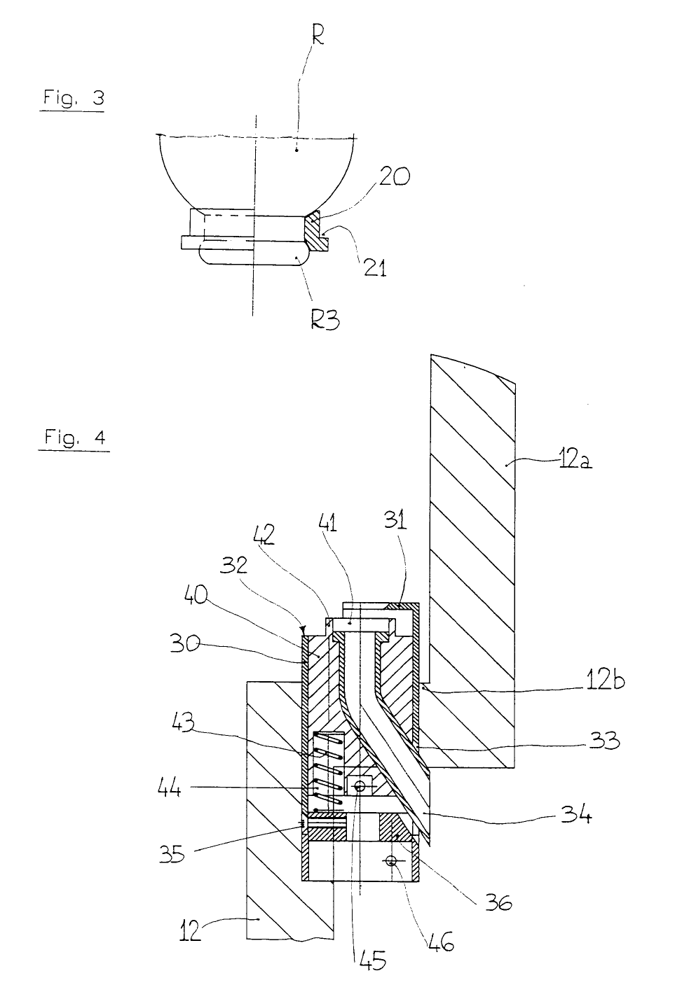

FIG. 3 represents a front and partially axial section view of a collar which is applied to the dispensing end of each tap as in FIGS. 1 and 2, in order to be able to effectively apply a connection device allowing the substantial insulation of the thermal treatment cell, compared to the control leverage at a relative distance, of the tap;

FIG. 4 represents a vertical and cross-sectional view of a connection device to be applied to the cell opening of FIG. 2, in order to be able to achieve the substantial thermal insulation thereof, even in the presence of a leverage or device for the drink control and dispensing, being intentionally partially shown in order to better indicate the operative parts thereof;

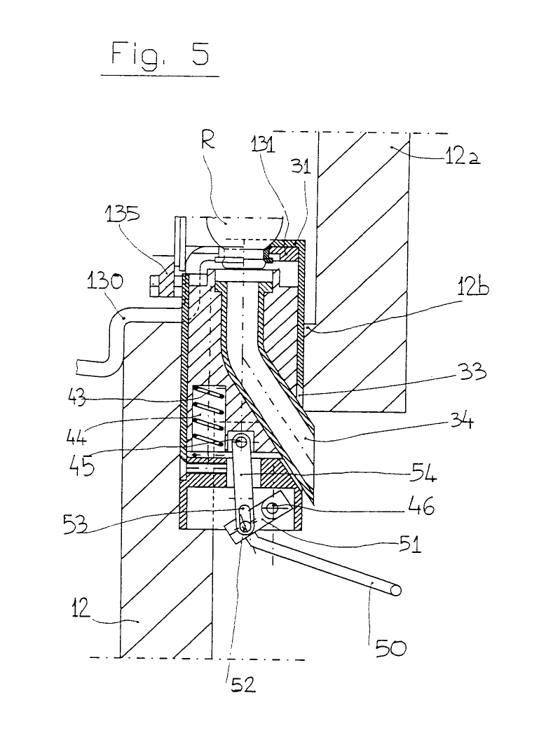

FIG. 5 represents a vertical and cross-sectional view of the connection device of FIG. 4, being shown complete with its application leverage and being shown in its transitory step of application of the connector or sleeve to the dispensing tap end as in FIG. 1;

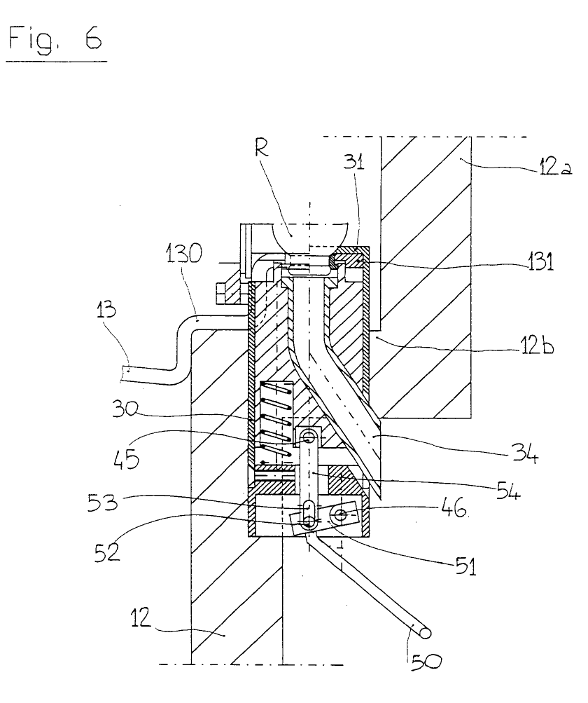

FIG. 6 represents a vertical view similar to the view in FIG. 5, being the same connection device shown in its standard condition of connection to the outlet end of the drink dispensing tap, while the base lever thereof has yet to be actuated in order to control the dispensing tap;

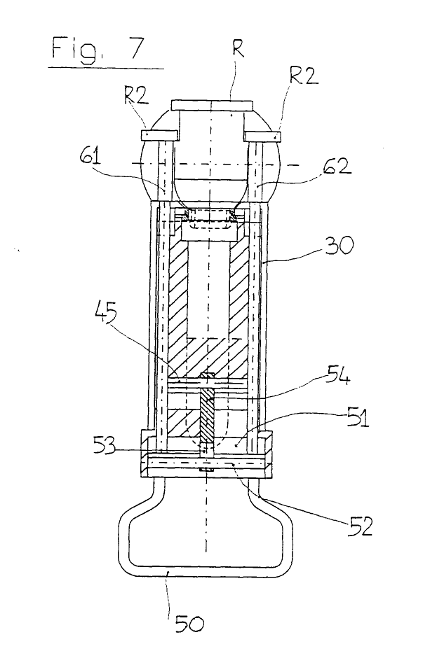

FIG. 7 represents a vertical and partially front sectional view of the device of FIGS. 5 and 6, with highlighting of the leverage parts adapted to the activation of the dispensing tap of FIG. 1;

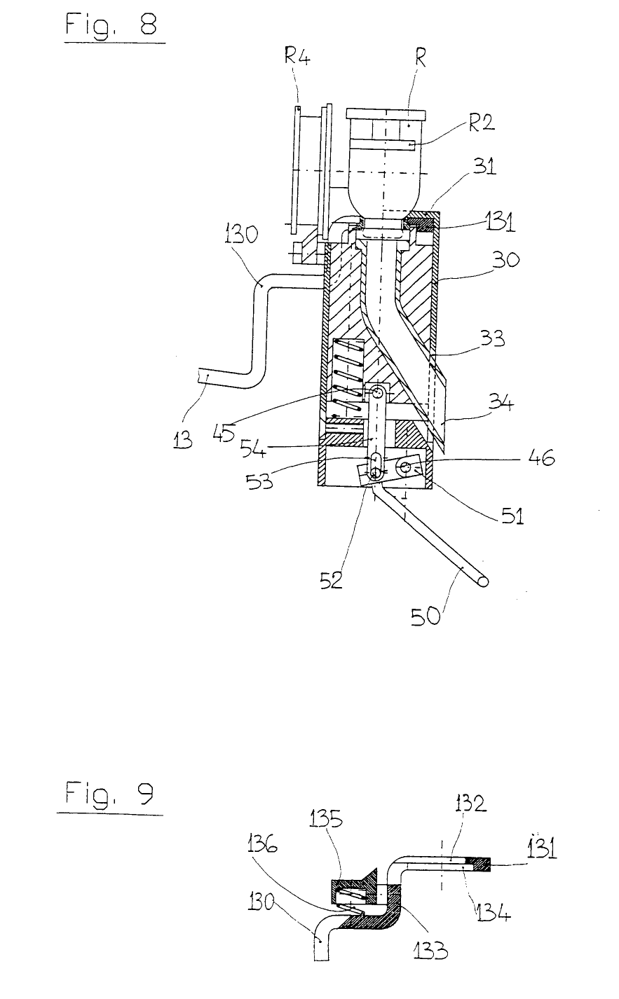

FIG. 8 represents a vertical and cross-sectional view of the connection device of FIGS. 5 to 7, with highlighting of the pre-fastening device of the tap to the fixed structure of the cell under examination, before its further fastening and supporting with a part of the closure opening of the cell;

FIG. 9 represents a cross-sectional view of a detail of the pre-fastening device of the tap to the fixed part of the cell, in accordance with FIG. 8;

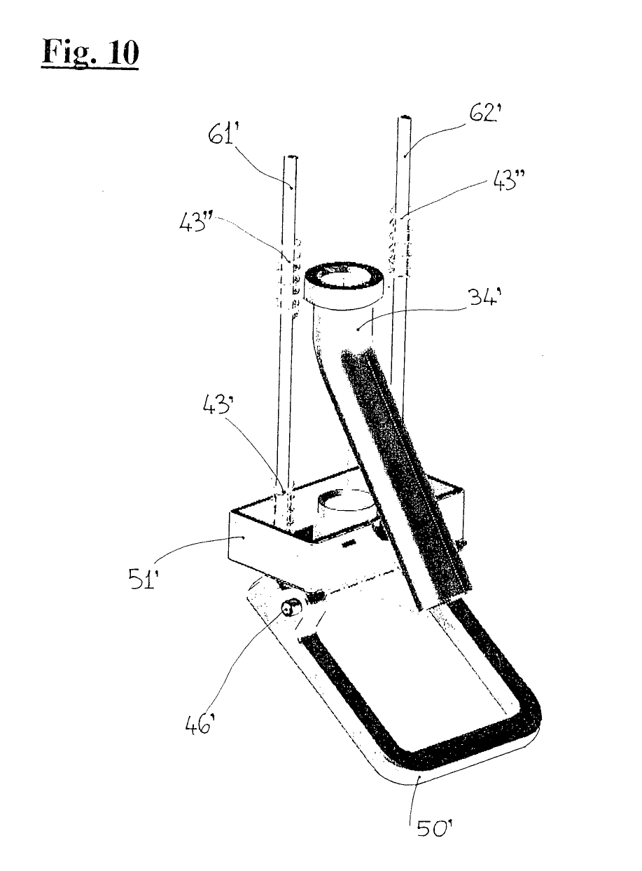

FIGS. 10 to 13 represent some perspective views of a first constructive variation of the cell under examination and, in more detail:

FIG. 10 represents a perspective view of a different leverage adapted to supply a similar drink dispensing sleeve;

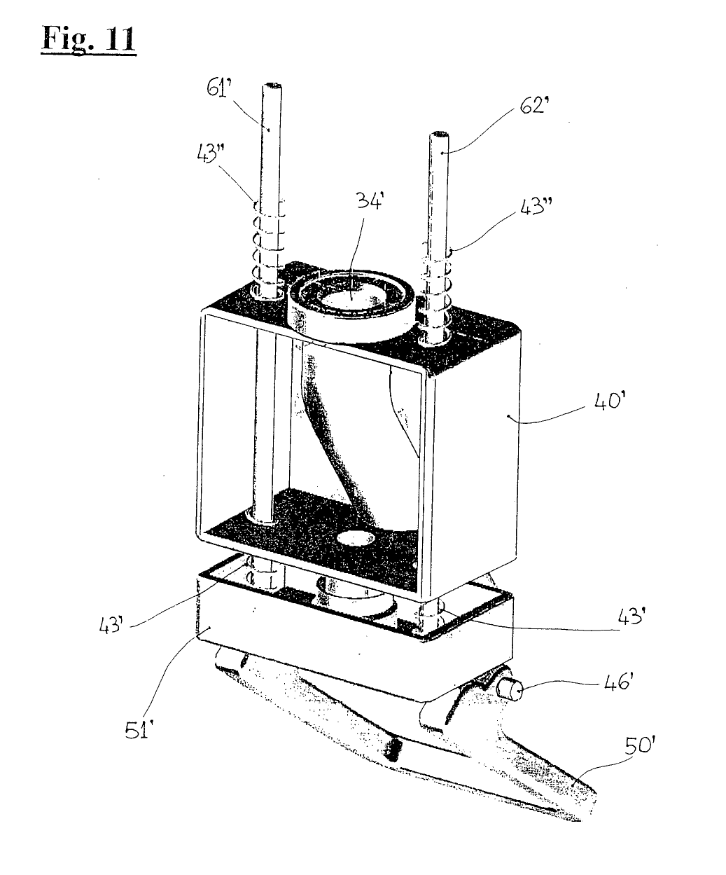

FIG. 11 represents an opposed perspective view of the same members of FIG. 10, associated to a holding part;

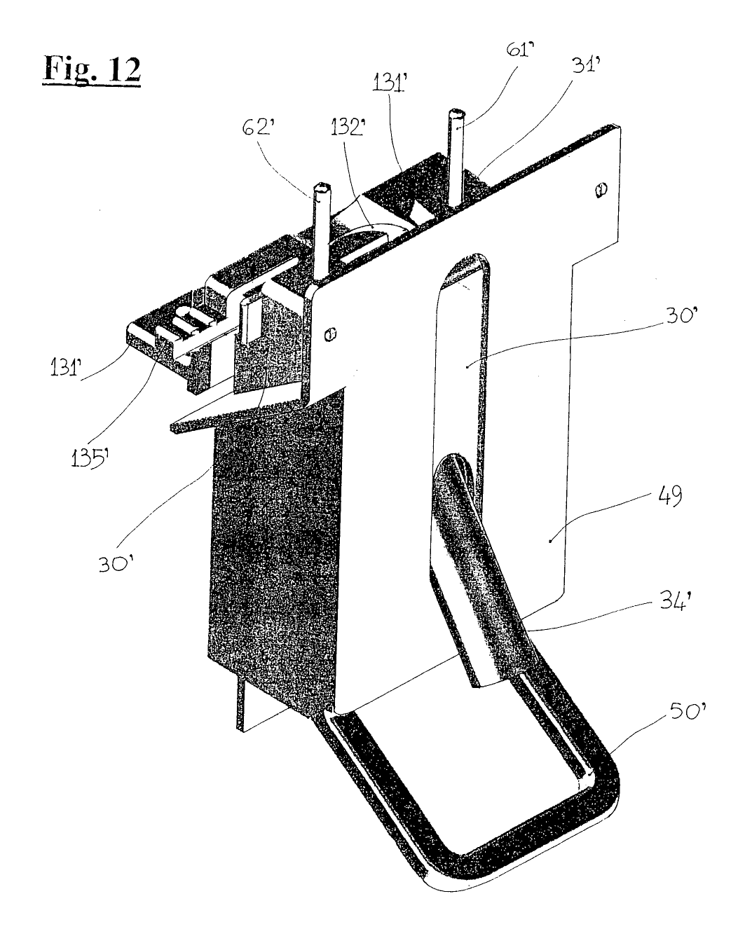

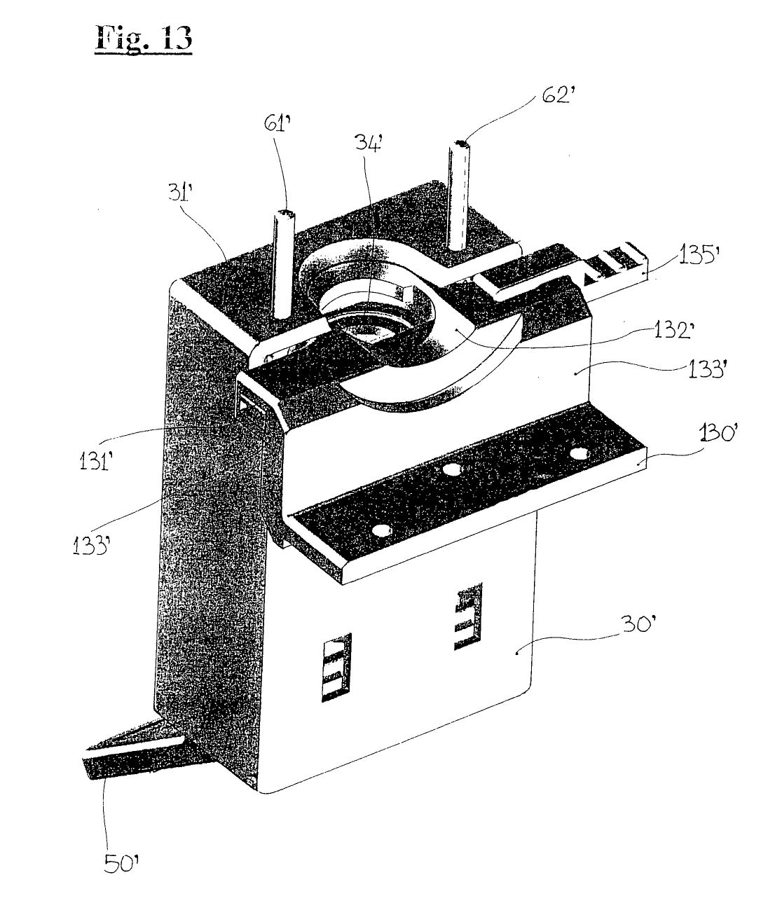

FIG. 12 represents a perspective view of the same members of FIGS. 10 and 11, housed in a container thereof to be applied and fastened to the cell opening;

FIG. 13 represents an opposed perspective view of the same members of FIGS. 10 and 11, in an opposed view, and before being housed in the container of FIG. 12.

In all the Figures, the same details are represented, or are meant to be represented, with the same reference number.

According to the constructive solution schematically illustrated in the several specified FIGS. 1 to 9, a cell (1), by way of example for the refrigeration, is adapted to accommodate at least one container (C) of the known type, having standardized dimensions and capacity, for example, a 5-liter container, and provided with a tap (R) for dispensing of the drink contained therein.

Said cell (1) is essentially composed of an inner space (11) which is closed on all sides, apart from the front side, where an opening (12) is hinged which has an upper part (12a) projecting from the lower part and provided with a small intermediate junction plane (12b), said opening (12) also having the function of allowing the insertion and placement of the stock containers (C2) and (C3), and of the container (C1) which is used, by suitably placing it on the grid or sloping base (13).

With reference to FIG. 2, the cell (1) is made so as to be able to thermally treat both the container (C1) already arranged for the dispensing, and another container (C2), for example a 3-liter container, and a further container (C3), for example a 5-liter container, located at the base of the same space (11), subject to temporary rotation or translation of the support grid (13).

Of course, different constructive solutions of similar cells (1) could be restricted to the holding of a single package (C1) or of a different number of such packages (C), by consequently adapting the dimensions and capacity of cell (1).

In FIG. 1 it is shown how a container (C) for the holding of drinks is usually composed of a pocket, not shown, made in suitable plastic material, which pocket is provided with a tap (R) which is made to project from the lower part of a pre-arranged side wall of a semi-rigid container (C), for example in cardboard/aluminium, to which wall it is in any case made somehow integral, generally by gluing or mechanical fastening of a flange (R1) adjacent to the inlet mouth of the tap (R).

It is known that the dispensing control of the tap (R) is allotted to the lifting of its fins (R2) which can be easy, where manually carried out, but becomes not very reliable when it is carried out with control leverages at a relative distance, since each lever, by biasing the fins (R2) upwards, tends to vertically move and bend the tap (R), causing poor dispensing efficacy and a shifting of the outlet axis of the drink.

It is clear that, by wishing to ensure a constant temperature of the drink of the container (C1) included in the cell (1), the tap (R) is intended to stay inside the isolated space (11), and it is therefore necessary to apply a leverage which, by acting from outside the cell (1), does not have spaces with substantial thermal dispersion, while ensuring the rigidity of the tap (R) even in the case of a biasing of such leverage.

Underlying the present invention the very problem of securing the tap (R) arises, both in order to be able to apply thereto a spaced control leverage for the drink dispensing, and in order to be able to apply thereto a sleeve which drives the dispensed drink to the nearest point of the glass (B) or collecting vessel, wishing to avoid that these devices may essentially affect the thermal seal of the cell (1), all of that by using packages (C) and taps (R) of a commercial type.

The achievement of these objects is made possible by the application, on the outlet mouth (R3), of the standard tap (R), of a collar (20), as exemplified in FIG. 3, such application being carried out, for example, in hot conditions and in a sufficiently plastic material.

From the same FIG. 3 it is inferred that said collar has a shoulder (21) the function of which is better illustrated herein below.

With reference to FIGS. 4 to 9, the device is illustrated below with which, after placing the container (C1) in the special position of the grid (13), and after pre-locating the tap (R) thereof on the same grid (13), said tap (R) is further and better integrally fastened to the opening (12) in the closed condition, on which the control leverage for the drink dispensing is located.

In particular, from FIG. 4 it is inferred that, on the connecting shelf (12b) between the lower part of the opening (12) and its projecting upper part (12a), and in a suitable axial position also with the cell (1), a jacket (30) is applied, preferably cylindrical, which has no bottom, and which has an upper edge (31), whereby said jacket (30) is suitably fastened to said horizontal junction (12b) connecting the opening (12) base and its upper projecting part (12a).

The upper edge (31) of the jacket (30) extends in the shape of a circular crown only along part of its circumference, for example along 180°, having only an abutting function, as described below, while a suitable notch (32) defines the height of the remaining part of jacket (30) adjacent to said edge (31).

Said jacket (30) is further provided with a radial hole (33) allowing the passage of the tip of a flexible sleeve or connector (34), and with suitable radial holes for the application of fastening screws (35) of a perforated disk (36) having holes, for the closure of the bottom of the jacket (30).

Said jacket (30) accommodates therein a cylinder (40), provided with a hole (41) which, by axially starting from the upper and raised surface (42), comes out radially, in order to be able to accommodate the flexible sleeve (34), which is intended to come out also from the hole (33) of the jacket (30), along a pre-established length.

Said cylinder (40) is inserted from the jacket (30) base and stays entrapped therein by the fastening of the perforated disk (36), with its screws (35), the disk (36) being biased upwards by at least one elastic means (43) having an end resting on the drilled disk (36) and the opposite end accommodated in the recess (44) of said cylinder (40).

The position of maximum height which is achievable by the cylinder (40), inside the jacket (30), is defined by the presence of a plug (45) which rests its fulcrum to a lever (54), and which is acting in co-operation with a plug (46) which is fastened to the lower end of the jacket (30), as illustrated below.

With particular reference to FIGS. 5 to 8, a leverage allowing the actuation of the fins (R2) of the tap (R) from a relative distance is shown, beside the preliminary placement of the flexible sleeve (34) against the outlet mouth (R3) of the tap, in order to be able to control the dispensing of the drink from the container (C1) to the glass (B), without substantial thermal dispersion of the cell (1) and without dispersion of the drink, in accordance with the various specified objects.

A control handle or lever (50) is rigidly integral to a plate (51), by being, for example, welded thereto, with suitable inclination.

Said plate (51) has one of its ends hinged to the plug (46) of the jacket (30), and has a pin (52), on its opposite end, which is entrapped in a slot (53) at an end of the lever (54), which rests its fulcrum to the pin (45) of the cylinder (40).

With specific reference to FIG. 5, it is shown that the cylinder (40) is locked inside the jacket (30) in vertical direction, after it has been inserted from below therein and closed by the drilled disk (36), the cylinder (40) being already complete with its elastic means (43), applied in the space (44), and with its lever (54) already applied to the plug (45) coming out of the drilled disk (36).

Still with reference to FIG. 5, it is clear that, with the hinging of the plate (51) to the plug (46), and with the housing of the pin (52) in the slot (53) of the lever (54), the biasing of the elastic means (43) on the cylinder (40) is limited by the axial position of the lever (54), allowing the movement of the cylinder (40) and of its flexible sleeve (34), subsequently inserted from above in the hole (41), from the open preparation position shown in FIG. 5, to the closure or permanent contact position of the sleeve (34) with the outlet mouth (R3) of the dispensing tap (R), as illustrated in FIG. 6, where said sleeve (34) allows avoiding any dispersion of dispensable drink.

FIG. 7 shows, the presence of a pair of shafts (61)-(62) which, having a lower end contacting the plate (51), are able to slide inside special side seats of the cylinder (40) and of the edge (31) of the jacket (30), having an opposite end which abuts against the lower part of the fins (R2) of the tap (R).

From the standard resting position of FIG. 6, by biasing the handle (50), for example, with the edge of the glass (B) to be filled in with drink, the plate (51) is forced to rotate on its pin (46), but without lifting the lever (54) and the cylinder (40), which already are at their maximum height with respect to the edge (R3) of the tap (R), because of their sliding along the slot (53).

The same biasing of the handle (50), however, causes the lifting of the vertical shafts (61) and (62), with consequent sliding in the seats of the cylinder (40) and edge (31), in order to effect the desired lifting of the fins (R2), by which the opening of the tap (R) and the dispensing of the drink of the container (C1) are controlled, while, upon ceasing the bias on the handle (50), the immediate lowering of the shafts (61) and (62) occurs, hence closing the tap (R).

From what has been until now described it is inferred how, in fact, the presence of the leverage (50)-(51)-(54) on the pins (45) and (46), and the shafts (61)-(62), beside the presence of the jacket (30) with the cylinder (40) and the sleeve (34) thereof, make possible a control of the tap (R) from a limited distance, thereby ensuring a substantial thermal sealing of the cell (1), and without dispersion of the drink to be dispensed along the gap from the tap (R) to the glass (B), in accordance with various specified objects.

With particular reference to FIG. 3, and to FIGS. 8 and 9, it is now to be better specified the arrangement by which the tap (R) stays motionless and without bending, during the bias of the shafts (61) and (62) which are actuated by the handle (50).

It has already been indicated that the container (C1) is preventively fastened in the correct position on the grid (13) inside the space (11) of the cell (1), by being positioned therein by means of saddles or guides dimensioned in relation to the container capacity, for example for 3- or 5-liter packages, and said grid (13) being able to be made liftable, for the housing of other stock packages (C2) and/or (C3).

The end (130) of said grid (13), in suitable axial position of the cell (1), has a projection (131) which is shaped as a fork or semicircular crown, having a co-axial hole (132) which is opened on the inner side of one shoulder (133) thereof.

The same projection (131) has an opened undercut or flaring (134) concentric to said hole (132), which is always open towards the inner side of the shoulder (133).

A little hook (135) is hinged to the wall (133) of the projection (131), and is associated with an elastic means (136), in order to be able to bend and thus accommodate the edge of a flange (R4) which is usually present in each tap (R), in order to allow a first fastening of the tap (R) in its correct position on the grid (13), at the time of positioning the package (C1).

In order to be able to arrange the flange (R4) in the pre-fastening little hook (135) of the tap (R), it is necessary to accommodate at the same time the base diameter of the collar (20), already applied on the outlet edge (R3) of said tap (R), in the seat (132) of the grid (13) and consequently accommodate its shoulder (21) in the flaring (134) of its end (131), thus ensuring both the vertical and the horizontal locking thereof.

A light pressure on the little hook (135) allows overcoming the force of the elastic means (136), thereby lightly lifting the flange (R4) and unlocking the tap (R) from the little hook (135) and the fork (131).

At the time of closing the opening (12), the semi-cylindrical or fork edge (31) of the said (30) is in superimposition with the end (131) and its fork hole (132) of the grid (13), cooperating so as to avoid any vertical oscillations, also in the bias step of the leverage on the fins (R2) of the tap (R) which is locked thereto.

At the same time, the raised edge (42) of the cylinder (40) is inserted in the flaring (134) of said end (131), causing a further radial locking of the tap (R), co-operating with the pre-fastening of the hook (135).

With the snugly locking of the tap (R), both to the fixed end (131) of the grid (13), and to the mobile edge (31) of the opening (12) of the cell (1), and to the transversal hook (135), the control at a relative distance of the fins (R2) of the tap (R) is made possible, which tap stays inside the space (11) at a controlled temperature, without causing the thermal dispersion for the drink which is contained in the container (C1), beside being able to dispense the drink to the edge of the collecting glass (B), by means of the flexible sleeve or connector (34), in accordance with the specified objects.

Of course, the constructive solution until now described and illustrated is to be meant, as already specified, merely indicative and not limiting.

It is, in fact, possible, for example, to provide another leverage, of a known type, in any case adapted to locate the sleeve (34) against the mouth (R3) of the tap (R) and to actuate the small levers (R2) of the tap (R), as well as it is possible to produce taps (R) which are already provided with an outlet mouth (R3) integrating the shape of the collar (20) and of the shoulder (21) thereof.

As already cited, with reference to FIGS. 10 to 13, a first constructive variation of the cell under examination is exemplificated and, in more detail, of the limited distance dispensing device thereof.

In particular, in FIGS. 10 and 11 a sleeve (34′) is represented, preferably made of rigid material and supported by a box (40′) which, in turn, is supported by elastic means (43′), which are driven by a pair of shafts (61′)-(62′) which are resting on the base plate (51′).

A pin (46′), integral to the plate (51′), allows for the hinging of a handle (50′) the eccentric end of which can bias upwards the plate (51′) until contacting the base side of the box (40′), overcoming the resistance of the springs (43′), while a suitable telescopic intermediate guide allows the appropriate verticality thereof.

A jacket (30′) is shaped so as to be able to stably and removably hold said box (40′) with the sleeve (34′) and the base plate (51′), letting only the bottom handle (50′) and the ends of the shafts (61′) and (62′) project, beside the end of said sleeve (34′).

Said jacket or container (30′) is provided with an upper surface (31′) with semicircle central opening which is adapted to accommodate the tap (R) base, while between said surface (31′) and the top of the box (40′) another pair of springs (43″) is interposed, which are wrapped to the shafts (61′)-(62′) and abutting against the inner surface of the plane (31′), in order to impart stability to the resting or closure position of the handle (50′).

Said jacket (30′) is then housed in a container (49) which allows the housing and fastening thereof to the inner surface of the lower part of the opening (12), so that from said opening (12) only the final end of the sleeve (34′) and the handle (50′) project.

According to this first constructive variation, in the space underlying the upper surface (31′) of the jacket (30′), a projection (131′) of the end (130′) inserts itself, which is secured to the grid (13) of the cell (1) by means of a appropriate base.

Said projection (131′) is semi-circular-fork-shaped, having its co-axial hole (132′) on the inner side of the shoulder (133′) thereof, where the collar (20) of the tap (R) is intended to be housed, in the same way as was already illustrated for the first version.

According to this second version, as a replacement of the small hook (135), for the first locking of the tap at the end (130′) of the grid (13), the presence of a lock bolt (135′) is provided which, by sliding along a special guide of the end (131′) slips manually into the undercut (R4) of the tap (R), thus ensuring an identical first locking.

According to this constructive solution, upon the movement of the handle (50′) a lifting of the plate (51′) is achieved, as well as a lifting of the sleeve (34′) mouth at the dispensing mouth (R3) of the tap (R) and a lifting of the shafts (61′) and (62′), which thereby act upon the fins (R2) of the tap (R), in order to effect its opening and the conveying of the drink of the container (C1) into the sleeve (34′), then in the glass (B) below.

As the illustrated one, other constructive variations are possible, for example providing the application of the tap (R) on the short side of the package (C), so as to be able to reduce the cell (C) height and to exploit its depth at best.

Again, it is possible to provide cells (1) which are provided with a space (11) adapted to accommodate only one package (C1), and completed, for example, by the presence of a handle, which makes the transport thereof easy in each dispensing situation of the refrigerated drink.

These and other similar modifications or adaptations are in any case to be intended as falling within the originality of the invention which is designed to be protected.

1. Cell with insulating connector, for the dispensing of refrigerated drinks, in packages which are interchangeable and provided with tap, indicatively contained in non-rigid pockets or packages and having a standardized capacity, characterized in that to provide the carrying out of a refrigerating, or in any case drink thermal treatment, said cell (1) is provided with an opening (12) which an insulating connector or sleeve (34) is applied to, which is adapted to have the upper edge thereof in connection with the dispensing mouth of the tap (R) of the package (C1) of the drink, said tap (R) being pre-arranged inside the isolated space (11) and pre-fastened to a hook (135) and a fork (131) of the grid or support plane (13) of the package (C1), while an edge (31) of the support jacket (30) of the sleeve (34) and of the actuation leverage at a relative distance of the tap (R) of the opening (12) co-operates with the fork (131) for the vertical stability of the tap (R), in particular in the biasing step of said leverage.

2. The cell with insulating connector, for the dispensing of refrigerated drinks, in packages which are interchangeable and provided with tap, as in claim 1, characterized by the fact that a sleeve or connector (34) allows the dispensing of the drink of the package (C1) from the tap (R), which is included in the isolated space (11) of the cell (1), to the external environment where the glass (B) or collecting vessel is located, for the interposition of a jacket (30) and of a cylinder (40) for the translation of the sleeve (34), being applied to the opening (12) of said cell (1) and allowing the positioning of the sleeve (34) on the tap (R) and the activation of a leverage which controls the lifting and lowering of the fins (R2) of said tap (R), for the dispensing at a relative distance, without thermal dispersions and dispersions of the drink.

3. The cell with insulating connector, as in claims 1 and 2, characterized by the fact that the positioning of the sleeve (34) and the dispensing leverage of the tap (R) are made possible by the presence of a collar (20), which is applied in proximity of the outlet mouth (R3) of the tap (R), or by forming a collar (20) with said mouth (R3), said collar (20) having a shoulder (21), in order to be able to be housed in a circular half-crown-shaped seat (132) with flaring (134) of an end or fork (131) of the grid or support base (13) of the package (C1) in the space (11) of the cell (1).

4. The cell with insulating connector, as in claim 3, characterized by the fact that the end (131) of the grid or support base (13) is provided with a small hook (135) hinged on the shoulder (133) thereof and associated to an elastic means (136), said small hook (135) being located in such a position to be able to accommodate a standard flange (R4) of a tap (R), thus co-operating with the fork (131) and the seat (132) upon pre-arrangement of the tap (R) of the package (C1) in the arrangement step of the container (C1) in the space (11) of the cell (1).

5. The cell with insulating connector, as in claims 3 and 4, characterized by the fact that the collar (20) and the shoulder thereof (21) of the tap (R) are accommodated in the spaces (132) and (134) of the fork (131), while the small hook (135) hinders the slipping off of the tap (R), ensuring its desired horizontal stability, beside hindering its vertical movement, under the effect of the abutment of the shoulder (121) in the seat (134) of the fork (131);

6. The cell with insulating connector, for the dispensing of refrigerated drinks, as in claims 1 and 2, characterized by the fact that, with the closure of the opening (12) against the edge of the space (11) of the cell (1), the edge (31) of the jacket (30), with the circular crown conformation thereof and with the upper opening (32) thereof superimposes to the fork crown (131) of the grid (13), in order to co-operate with the rigidity of said fork (131) also in the biasing step on the fins (R2) of the tap (R), always ensuring the best operative conditions for the dispensing of the drink from the container (C1).

7. The cell with insulating connector, as in claim 2, characterized by the fact that a connector or sleeve (34) is made of suitable flexible material, of a food grade, and by the fact of being able to be inserted and interchangeable in the space (41) of the cylinder (40), by using the opening (32) of the jacket (30), with an end which is made passing through the hole (33) of the jacket (30), for the translation of the drink, from the outlet mouth (R3) of the tap (R), to the desired position of the edge of a glass (B) or similar collecting vessel for said drink to be consumed.

8. The cell with insulating connector, as in claims 1 and 2, characterized by the fact that a cylinder (40) is entrapped in a jacket (30), by means of a drilled disk (36) which is applied to the base of the jacket (30) and which serves to the supporting function of an elastic means (43), adapted to bias said cylinder (40) and the sleeve (34) thereof against the outlet mouth (R3) of the tap (R), beside biasing the raised edge (42) thereof inside the flaring (134) of the fork (131), for co-operating to the horizontal stability of the tap (R).

9. The cell with insulating connector, as in claim 8, characterized by the fact that the biasing of the elastic means (43) on the cylinder (40) is limited also by the presence of a lever (54) which has one of its ends hinged to the pin or plug (45) integral to the cylinder (40) and which comes out from the drilled disk (36) of the jacket (30);

10. The cell with insulating connector, as in claims 8 and 9, characterized by the fact that a lever (54), having an end hinged to the plug (45) of the cylinder (40), has an opposite end having a slotted hole (53) in which a pin (52) integral to a plate end (51) can translate.

11. The cell with insulating connector, as in claims 8-9, and 10, characterized by the fact that a plate (51) has an end provided with pin (52) which is made translatable in the slot (53) of a lever (54), while the opposite end thereof is hinged to a plug (46) which is made integral to the wall of the lower space of a jacket (30).

12. The cell with insulating connector, as in claims 8 to 11, characterized by the fact that a plate (51) is integral to a handle (50) which allows biasing it in the lower space of the jacket (30), in order to make it to rotate around the pin or plug (46) thereof.

13. The cell with insulating connector, as in claims 1-2, and 12, characterized by the fact that a pair of shafts (61) and (62) have a lower end resting on the plate (51) and an opposed upper end resting on the lower surface of the fins (R2) of the tap (R) of the package (C1), while the same shafts are driven by suitable seats located along the cylinder (40) and by suitable holes on the edge (31) of the jacket (30).

14. The cell with insulating connector, for the dispensing of refrigerated drinks, as in any one of the claims 1 to 13, characterized by the fact that by biasing on the lever (50), after an initial translation of the connector (34) on the mouth (R3) of the tap (R), the control at a relative distance of the fins (R2) of the same tap (R) occurs, for the dispensing of the drink of the package (C1), and for the immediate suspension thereof, upon the ceasing of the bias to said handle (50), without thermal and drink dispersion.

15. The cell with insulating connector, for the dispensing of refrigerated drinks, in packages which are interchangeable and provided with tap, as in claim 1, characterized by the fact of providing the carrying out of a refrigerating, or in any case drink thermal treatment, cell (1), which is provided with an opening (12) which a sleeve (34) is applied to, which is adapted to have the upper edge thereof in connection with the dispensing mouth (R3) of the tap (R) of the package (C1), said tap (R) being arranged inside the isolated space (11), pre-fastened by a bolt lock (135′) and to a fork (131′) of the grid (13), for the support of the same package (C1), while an edge (31′) of the support jacket (30′) of the sleeve (34′) and of the actuation leverage at a relative distance (50′)-(61′)-(62′) of the tap (R) of the opening (12) co-operates with the fork (132′) for the vertical stability of the tap (R), in particular in the biasing step of the handle (50′).
